(19) United States
(12) Patent Application Publication
(10) Pub. No.: US 2016/0104469 A1
(43) Pub. Date: Apr. 14, 2016

(54) MUSICAL-PERFORMANCE ANALYSIS METHOD AND MUSICAL-PERFORMANCE ANALYSIS DEVICE

(71) Applicant: YAMAHA CORPORATION, Shizuoka (JP)

(72) Inventors: Yu TAKAHASHI, Hamamatsu-shi, Shizuoka (JP); Yoshitaka URATANI, Hamamatsu-shi, Shizuoka (JP); Fukutaro OKUYAMA, Hamamatsu-shi, Shizuoka (JP); Taro KAWABATA, Hamamatsu-shi, Shizuoka (JP); Koichi ISHIZAKI, Hamamatsu-shi, Shizuoka (JP); Dan SASAI, Hamamatsu-shi, Shizuoka (JP); Yoshinari NAKAMURA, Hamamatsu-shi, Shizuoka (JP); Daichi WATANABE, Hamamatsu-shi, Shizuoka (JP); Risa KOMURO, Hamamatsu-shi, Shizuoka (JP)

(21) Appl. No.: 14/892,764

(22) PCT Filed: May 23, 2014
(86) PCT No.: PCT/JP2014/063722

§ 371 Date: Nov. 20, 2015

(30) Foreign Application Priority Data
May 23, 2013 (JP) 2013-108708

(51) Int. Cl. G10G 1/00; G09B 15/00; G10H 1/00

(52) U.S. Cl. CPC G10G 1/00; G10H 1/0008; G10H 1/0041; G09B 15/00; G10H 2210/091; G10H 2210/066

(57) ABSTRACT

A musical-performance analysis device includes: an acquisition section that acquires performance information of a player; a determination section that determines, by comparing the performance information acquired by the acquisition section with reference information indicating a reference of a performance, among performance segments different from one another, a performance segment in which a difference degree between the performance information acquired by the acquisition section and the reference information is large and a performance segment in which the difference degree between the performance information acquired by the acquisition section and the reference information is small; and the specification section that specifies a tendency of the performance on the basis of the difference degree of the performance segment in which the difference degree has been determined to be small by the determination section.

### TECHNICAL FIELD

The present invention relates to a technique to analyze a performance of a musical instrument.

### BACKGROUND ART

There are known techniques to evaluate the skill of a performance of a musical instrument. For example, Patent Literature 1 describes the following: Performance data is compared with sequence data in terms of each note, and if an error is made in a scale, if there is an extra sound or if one sound is missed, one is subtracted from the total number of notes, so that the final number of notes, namely, the number of notes correctly played, is defined as a progress degree corresponding to a skill index of the performance. Patent Literature 1 further describes that an estimated amount of practice necessary for learning a performance technique is obtained on the basis of the progress degree.

### CITATION LIST

### Patent Literature

Patent Literature 1: JP-A-2013-068879

### SUMMARY OF INVENTION

### Technical Problem

In an actual performance, there is a situation that a player does not play exactly in accordance with a musical score but cannot be said to have made a failure or a mistake in the performance. The situation corresponds to, for example, a case where the player plays slightly slower than a prescribed timing or plays with a musical symbol shown in the musical score slightly emphasized. This will be herein designated as a performance habit, and in some cases, such a habit is preferably broken to play more exactly in accordance with the musical score. On the other hand, however, a famous player may intentionally play not in accordance with a musical score for expressing given feeling in some cases. This will be herein designated as performance individuality. Such performance individuality is, differently from the above-described performance habit, a preferable performance technique for improving the artistic quality of the performance in many cases. In the technique described in Patent Literature 1, it is determined merely whether or not a player has made a failure or a mistake in the performance, and therefore, such a performance habit or individuality (hereinafter generically designated as the “performance tendency”) cannot be evaluated.

The present invention is accomplished in consideration of the aforementioned background, and an object is to specify a performance tendency distinguishably from a failure or a mistake made in a performance.

### Solution to Problem

The present invention provides a musical-performance analysis method including: an acquisition step of acquiring performance information of a player; a determination step of determining, by comparing the performance information acquired in the acquisition step with reference information corresponding to a reference of a performance, among performance segments different from one another, a performance segment in which a difference degree between the performance information acquired in the acquisition step and the reference information is large and a performance segment in which the difference degree between the performance information acquired in the acquisition step and the reference information is small; and a specification step of specifying a tendency of the performance on the basis of the difference degree of the performance segment in which the difference degree has been determined to be small in the determination step.

Besides, the present invention provides a musical-performance analysis device including: an acquisition section that acquires performance information of a player; a determination section that determines, by comparing the performance information acquired by the acquisition section with reference information indicating a reference of a performance, among performance segments different from one another, a performance segment in which a difference degree between the performance information acquired by the acquisition section and the reference information is large and a performance segment in which the difference degree between the performance information acquired by the acquisition section and the reference information is small; and a specification section that specifies a tendency of the performance on the basis of the difference degree of the performance segment in which the difference degree has been determined to be small by the determination section.

### Advantageous Effect of Invention

According to the present invention, a performance tendency can be specified distinguishably from a failure or a mistake made in a performance.

### BRIEF DESCRIPTION OF DRAWINGS

FIG. 1 is a diagram illustrating the entire configuration of a musical-performance analysis system 1 according to an embodiment of the present invention.

FIG. 2 is a diagram illustrating the appearance of an electronic musical instrument 10.

FIG. 3 is a diagram illustrating the hardware configuration of the electronic musical instrument 10.

FIG. 4 is a diagram illustrating the hardware configuration of a server device 20.

FIG. 5 is a flowchart illustrating a process flow conducted by the electronic musical instrument 10.

FIG. 6 is a diagram illustrating an example of a screen displayed by the electronic musical instrument 10.

FIG. 7 is a flowchart illustrating a process flow conducted by the server device 20.

FIG. 8 is a diagram explaining a concept to be employed in specifying a difference degree of a sound emitting timing.

### DESCRIPTION OF EMBODIMENT

### Embodiment

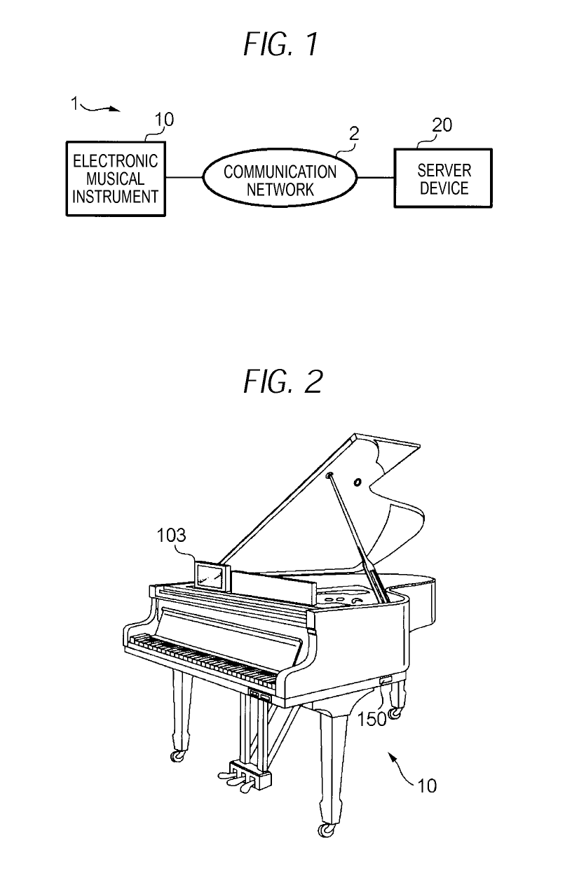

FIG. 1 is a diagram illustrating the entire configuration of a musical-performance analysis system 1 according to an embodiment of the present invention. In the musical-performance analysis system 1, an electronic musical instrument 10 used by a player for a performance and a server device 20 functioning as a musical-performance analysis device for analyzing the performance are connected to a communication network 2 such as the Internet. Incidentally, although a large number of electronic musical instruments 10 and server devices 20 can be connected to the communication network 2, merely one electronic musical instrument 10 and merely one server device 20 are illustrated in FIG. 1 for avoiding the complication of the drawing.

(Configuration of Electronic Musical Instrument 10)

FIG. 2 is a diagram illustrating the appearance of the electronic musical instrument 10. The electronic musical instrument 10 is, in the present embodiment, an automatic playing piano. The electronic musical instrument 10 is equipped with the same mechanisms as those of a general acoustic piano including an action mechanism for striking strings in accordance with the movement of keys of a keyboard and dampers for stopping string vibration. Besides, the electronic musical instrument 10 is equipped with the same configuration as that of a general automatic playing piano including an actuator for driving the keys and a sensor for detecting the movement of the keys. Furthermore, the electronic musical instrument 10 is equipped with an interface 150 through which various information is input/output, and a touch panel 103 for displaying a screen or the like for operating the electronic musical instrument 10 and accepting an instruction from an operator.

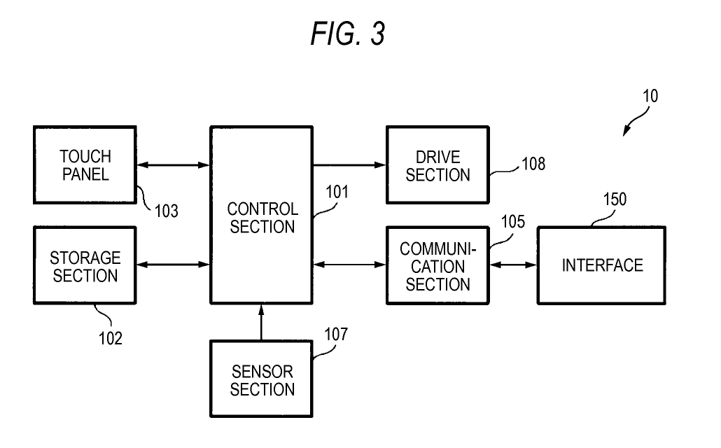

FIG. 3 is a block diagram illustrating the hardware configuration of the electronic musical instrument 10. A storage section 102 includes a nonvolatile memory, and stores, for example, an instrument identifier for uniquely identifying the electronic musical instrument 10. A communication section 105 is connected to the interface 150. The communication section 105 has a function to communicate with the server device 20 via the interface 150 connected to the communication network 2.

A sensor section 107 includes a sensor for detecting the movement of a key of the keyboard. The sensor is provided correspondingly to each key of the keyboard, and when the key is operated by a player for conducting a performance, a signal corresponding to the movement of the key is output from the sensor 107 to a control section 101. A drive section 108 includes an actuator (such as a solenoid) for driving a key of the keyboard. The actuator is provided correspondingly to each key of the keyboard, and when the actuator is driven, the key is operated to operate the action mechanism in accordance with the operation of the key, and thus, a string is stuck.

The control section 101 is a microcontroller including a CPU (Central Processing Unit), a ROM (Read Only Memory) and a RAM (Random Access Memory). When the CPU executes a program stored in the ROM, an automatic playing function is realized. Besides, when the CPU executes a program stored in the ROM, a function to generate a MIDI (Musical Instrument Digital Interface: registered tradename) message in accordance with the operation of the keyboard and a function to measure date and time, and the like are realized. The control section 101 controls the communication section 105 so as to transmit the generated MIDI message, date/time information and the like to the server device 20. The MIDI message and the date/time information are performance information of a player, and correspond to a result of the performance of the player. Besides, the control section 101 controls the communication section 105 to acquire a MIDI message, date/time information and the like stored in the server device 20. The control section 101 can also conduct an automatic performance by controlling the drive section 108 in accordance with MIDI messages and date/time information.

(Configuration of Server Device 20)

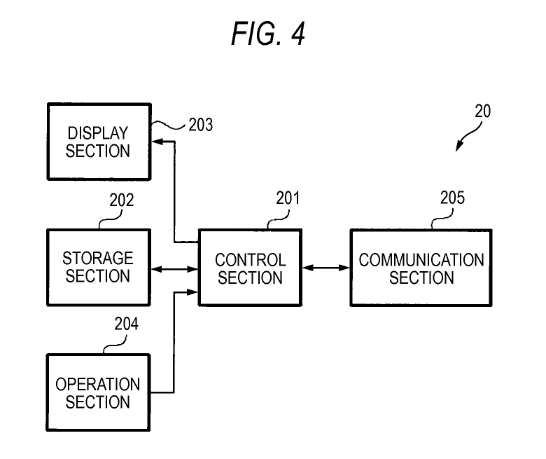

FIG. 4 is a block diagram illustrating the hardware configuration of the server device 20. A communication section 205 functions as an interface for conducting communication via the communication network 2, and communicates with another device under control of a control section 201. A display section 203 includes a display device, and displays various screens to be used for operating the server device 20. An operation section 204 includes a keyboard and a mouse to be used for operating the server device 20. When the keyboard and the mouse of the operation section 204 are operated, various instructions from a player to the server device 20 are input.

A storage section 202 includes a hard disk drive, and stores various information transmitted from the electronic musical instrument 10 and programs for realizing server functions in a client-server system. Besides, the storage section 202 stores performance reference information including MIDI messages according to a musical score of each tune, date/time information corresponding to a sound emitting timing of each note according to the musical score and date/time information corresponding to a timing to stop the sound emission (hereinafter, a sound stopping timing) of each note. This performance reference information is used as a reference in analyzing a performance of a player. The control section 201 is hardware for controlling the respective sections, and includes a CPU, a ROM, a RAM and the like. The CPU of the control section 201 controls the respective sections of the server device 20 by reading a program stored in the storage section 202 and executing the program. When the CPU of the control section 201 executes a program stored in the storage section 202, a function to store, in the storage section 202, various information transmitted from the electronic musical instrument 10, a function to specify a performance tendency for analyzing a performance on the basis of MIDI messages and date/time information out of the various information having been stored, a function to transmit various information stored in the storage section 202 to the electronic musical instrument 10, and the like are realized in the server device 20.

Next, an exemplary operation of the present embodiment will be described.

(Recording of Performance)

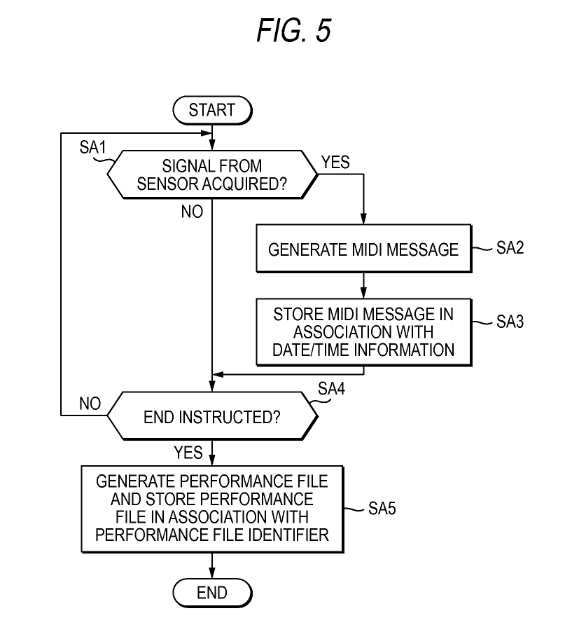

When a performance is to be conducted, a player conducts an operation to instruct the start of a performance in the touch panel 103. At this point, the player inputs the title or the identifier of a tune to be played to the electronic musical instrument 10. When the operation to instruct the start of a performance is conducted, the control section 101 starts recording a MIDI message. Specifically, when a signal output from the sensor section 107 in response to the player pressing a key is acquired (FIG. 5: YES in step SA1), the control section 101 generates, in accordance with the signal output from the sensor section 107, a MIDI message including performance operation information such as a note-on message, a note number corresponding to the pressed key, and a velocity corresponding to the operation conducted on the key (step SA2). The control section 101 causes the storage section 102 to store the note-on MIDI message in association with date/time information output by a timer section 1003 when the MIDI message is generated (step SA3).

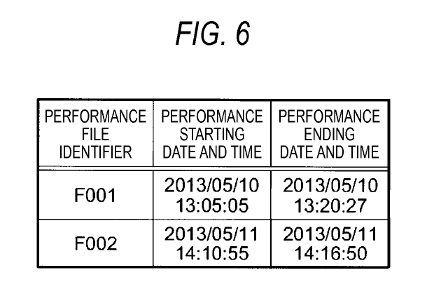

Next, in the electronic musical instrument 10, when a signal output from the sensor section 107 in response to the player removing his/her finger off from the pressed key is acquired (FIG. 6: YES in step SA1), the control section 101 generates, in accordance with the signal output from the sensor 107, a MIDI message including performance operation information such as a note-off message, a note number corresponding to the released key, and a velocity corresponding to the operation conducted on the key (step SA2). Besides, the control section 101 causes the storage section 102 to store this note-off MIDI message in association with date/time information output from the timer section 1003 when the MIDI message is generated (step SA3). Every time a key is operated, the control section 101 generates a MIDI message and causes the storage section 102 to store the generated MIDI message in association with date/time information.

For ending the performance, the player conducts, in the touch panel 103, an operation to instruct the end of the recording of the performance. When the operation to instruct the end of the recording of the performance is conducted (YES in step SA4 or YES in step SB4), the control section 101 generates a performance file by putting, in one file, the MIDI messages and the date/time information stored from the acceptance of the instruction to start the recording of the performance until the acceptance of the instruction to end the recording of the performance. The control section 101 generates a performance file identifier for uniquely identifying the generated performance file, and causes the storage section 102 to store a performance file including this performance file identifier and the title or the identifier of the tune having been input by the player.

If the performance file is to be stored in the server device 20, the player conducts, in the touch panel 103, an operation to instruct to display a list of performance files. When this operation is conducted, the control section 101 refers to performance files stored in the storage section 102, and controls the touch panel 103 to display the list of the performance files. The player selects a desired performance file from the list, for example, as one illustrated in FIG. 6, and when an operation to instruct to transmit the selected performance file to the server device 20 is conducted in the touch panel 103, the control section 101 reads the performance file selected by the player and the instrument identifier from the storage section 102, and controls the communication section 105 to transmit these information to the server device 20.

When the communication section 205 of the server device 20 receives the performance file and the instrument identifier transmitted from the electronic musical instrument 10, the control section 201 causes the storage section 202 to store the performance file and the instrument identifier received by the communication section 205 in association with each other. Incidentally, the control section 101 may transmit the performance file to the server device 20 in parallel to the generation and storage of the performance file even if the player does not instruct to store it in the server device 20. Besides, the control section 101 may automatically transmit the performance file to the server device 20 when the player conducts the operation to instruct to end the recording of the performance.

(Analysis of Performance)

The control section 201 compares the MIDI messages and the date/time information held in the performance file with the performance reference information of the same tune precedently stored in the storage section 202, and specifies a performance tendency on the basis of a degree of the difference therebetween (hereinafter referred to as the difference degree). Specifically, this is conducted as follows.

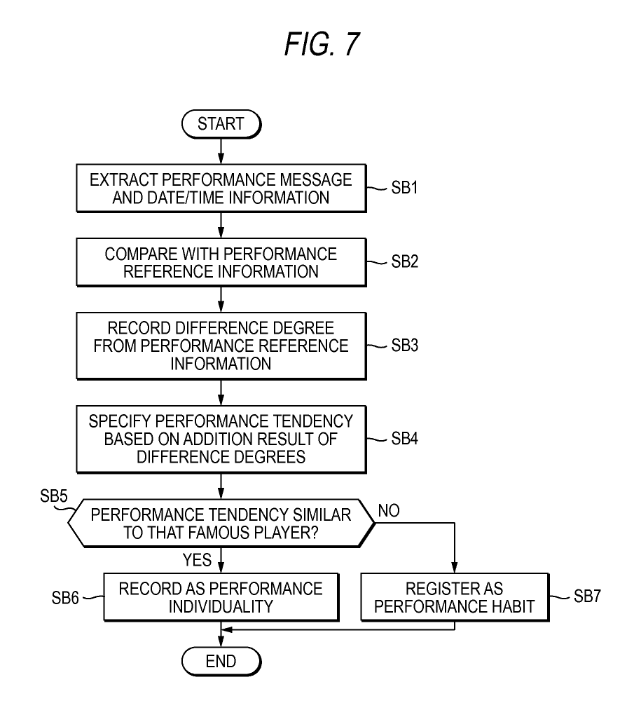

In FIG. 7, the control section 201 extracts the MIDI messages and the date/time information from the performance file stored in the storage section 202 (step SB1). Here, the control section 201 functions as a performance information acquisition section for acquiring performance information of a player. On the other hand, the performance reference information precedently stored in the storage section 202 includes the MIDI messages and the date/time information in accordance with the musical score as described above. The control section 201 compares, in terms of each note, the MIDI messages and the date/time information contained in the performance file with the MIDI messages and the date/time information contained in the performance reference information (step SB2). Then, the control section 201 records a difference degree therebetween in terms of each note.

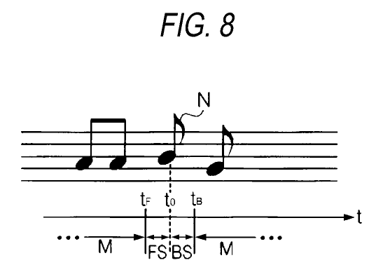

Herein, an example pertaining to a sound emitting timing will be principally described as the difference degree. FIG. 8 is a diagram explaining a concept to be employed in specifying the difference degree of the sound emitting timing. Musical notes illustrated in an upper portion correspond to the contents of performance reference information. In the performance reference information, it is assumed, for example, that the sound emitting timing of a given note N is at a time t₀ on the time axis. It is also assumed that a time prior to the time t₀ by a prescribed time period on the time axis is a time t_{F}, and that a time posterior to the time t₀ by a prescribed time period on the time axis is a time t_{B}. A period between the time t_{F} and the time t₀ (not inclusive) is designated as a prior-play period FS of the note N, and a period between the time t₀ (not inclusive) to the time t_{B} is designated as a posterior-play period BS of the note N. Besides, a period prior to the time t_{F} (not inclusive) and a period posterior to the time t_{B} (not inclusive) are designated as failed-play periods M of the note N.

If the sound emitting timing of the player playing the note N falls into the failed-play period M, a difference degree from the performance reference information (a time difference from the time t₀) is comparatively large, and hence, it is regarded as a failure or a mistake made in the performance. Alternatively, if the sound emitting timing of playing the note N falls into the prior-play period FS or the posterior-play period BS, a difference degree from the performance reference information (a time difference from the time t₀) is comparatively small, and hence, it is regarded not as a failure or a mistake made in the performance but as a performance tendency within a range allowable as a correct performance. Then, if the number of times of emitting sound in the prior-play periods FS is large and the number of times of emitting sound in the posterior-play periods BS is small, it is presumed that there is a tendency of an early timing in the performance, and if the number of times of emitting sound in the prior-play periods FS is small and the number of times of emitting sound in the posterior-play periods BS is large, it is regarded that there is a tendency of a delayed timing in the performance. The control section 201 compares the MIDI messages held in the performance file with the MIDI messages contained in the performance reference information to specify correspondences of notes between these messages, and records, as difference degrees, time differences in the sound emitting timing by referring to the date/time information corresponding to the notes (step SB3). Specifically, the control section 201 records which of the failed-play period M, the prior-play period FS and the posterior-play period BS the sound emitting timing of the player playing each note falls into. Then, the control section 201 sums up the difference degrees of the respective notes with respect to each of the failed-play period M, the prior-play period FS and the posterior-play period BS, so as to specify the performance tendency (step SB5).

Incidentally, in specifying the difference degree of each sound emitting timing, the difference degree is obtained by using the sound emitting timing of the note N as a reference, but instead, the sound emitting timing of a note immediately before the note N may be used as a reference, so that the difference degree can be obtained on the basis of a time difference between this reference and the sound emitting timing of the player playing the note N.

Specific rules to be applied here are, for example, as follows: (Rule 1) In a group of notes to be analyzed, with notes having the sound emitting timings falling into the failed-play periods M excluded, if a ratio of notes having the sound emitting timings falling into the prior-play periods FS is 20% or more, there is a performance tendency of an early timing; and (Rule 2) in a group of notes to be analyzed, with notes having the sound emitting timings falling into the failed-play periods M excluded, if a ratio of notes having the sound emitting timings falling into the posterior-play periods BS is 20% or more, there is a performance tendency of a delayed timing.

The control section 201 specifies the performance tendency with respect to, for example, a prescribed number of bars of the tune by applying the above-described Rules 1 and 2. Here, the control section 201 functions as a determination section for determining, by comparing the performance information of the player with the reference information corresponding to the reference of the performance, among performance segments (segments of respective notes) different from one another, a performance segment in which a difference degree therebetween is large (a segment of a note falling into a failed-play period M) and a performance segment in which a difference degree therebetween is small (a segment of a note falling into a prior-play period FS or a posterior-play period BS).

Furthermore, with the performance tendency of a famous player precedently prepared, the control section 201 compares the performance tendency specified in step SB4 with the performance tendency of the famous player, and determines that the performance tendency is similar to that of the famous player if a similarity degree therebetween is equal to or higher than a threshold value (YES in step SB5). As the performance tendency of the famous player, a performance tendency (for example, whether the performance is conducted at an early timing or a delayed timing) with respect to a prescribed number of bars is precedently stored in the storage section 202. For example, with respect to a prescribed number of bars, the performance tendency of the famous player is compared with the performance tendency specified in step SB5, and the similarity degree is calculated by determining what rate, in the whole tune, the tendencies accord with each other. Then, the control section 201 records, in association with the performance file, the name of the famous player and that there is performance individuality similar to the famous player (step SB6).

On the other hand, if the similarity degree is lower than the threshold value, the control section 201 determines that the performance tendency is not similar to that of the famous player (No in step SB5). Then, the control section 201 records, in association with the performance file, that there is, as a performance habit, a tendency of an early sound emitting timing or a delayed sound emitting timing (step SB7). In this manner, the control section 201 functions as a specification section for specifying the performance tendency on the basis of a difference degree of a performance segment determined to be small. The performance tendency thus specified is informed the electronic musical instrument 10 from the server device 20, and when displayed in the electronic musical instrument 10, the player can recognize it.

Although the example of the analysis for the sound emitting timing has been described above, a sound stopping timing can be used as a target of the analysis. Apart from this, with respect to the velocity, the pitch (in case of a stringed instrument), or musical symbols such as pianissimo, piano, mezzo piano, mezzo forte, forte and fortissimo, the control section 201 can compare the performance file with the performance reference information in the same manner as described above, so as to specify the performance tendency on the basis of a difference degree therebetween (for example, with respect to the velocity, a difference between a velocity value of the performance file and a velocity value of the performance reference information is used as the difference degree, or with respect to the pitch, a difference between a pitch value of the performance file and a pitch value of the performance reference information is used as the difference degree).

(Reproduction of Performance)

Next, an operation to reproduce a performance file will be described. If a performance file stored in the storage section 102 is to be reproduced, a player first conducts, in the touch panel 103, an operation to request a list of performance files stored in the server device 20, and then, a message including the instrument identifier and requesting the list of performance files is transmitted from the electronic musical instrument 10 to the server device 20.

When this message is received by the server device 20, the control section 201 generates a list of performance files associated with the instrument identifier included in the received message, and transmits the generated list to the electronic musical instrument 10. When the list transmitted from the server device 20 is received by the communication section 105 of the electronic musical instrument 10, the control section 101 causes the touch panel 103 to display, in accordance with the received list, a performance file identifier, a performance starting date and time and a performance ending date and time, for example, as illustrated in FIG. 6.

When the player selects a performance file in the displayed list and conducts, in the touch panel 103, an operation to instruct to acquire the selected performance file, the control section 101 transmits, to the server device 20, a message including the performance file identifier of the performance file selected by the player and requesting the performance file.

When this message is received by the server device 20, the control section 201 retrieves, from the storage section 202, the performance file associated with the performance file identifier included in the received message. Then, when the performance file including the performance file identifier is found, the server device 20 transmits the found performance file to the electronic musical instrument 10. When the performance file transmitted from the server device 20 is received by the electronic musical instrument 10, the control section 101 causes the storage section 102 to store the received performance file. Thereafter, when an operation to instruct to display the performance file stored in the storage section 102 is conducted in the touch panel 103, information of the performance file acquired from the server device 20 is displayed in the list of the performance files. Here, the performance file identifier included in the performance file, information of the earliest date and time among times included in the performance file (i.e., the performance starting date and time) and information of the last date and time among the times included in the performance file (i.e., the performance ending date and time) are displayed in the touch panel 103 as illustrated in FIG. 6. When the player selects the performance file acquired from the server device 20 in the displayed list and an operation to instruct to reproduce the selected performance file is conducted in the touch panel 103, the performance file acquired from the server device 20 is reproduced.

Specifically, the control section 101 controls the drive section 108 on the basis of MIDI messages, included in the performance file, in order of the date/time information associated with the respective MIDI messages. In other words, the control section 101 functions as a reproduction section for reproducing a performance on the basis of a performance file. Assuming, for example, that a note-on message with date/time information of “13:06:05” is followed by a note-off message with date/time information of “13:06:06”, the note-off message follows the note-on message after one second, and therefore, the control section 101 drives a key in accordance with the note-off MIDI message one second after driving the key in accordance with the note-on MIDI message. Then, when information associated with the last date/time information included in the performance file has been processed, the control section 101 completes the reproducing processing of the performance file.

According to the present embodiment, it is possible to specify a performance tendency, which cannot be said as a failure or a mistake made in a performance although the performance is not conducted exactly in accordance with a musical score. Besides, it is possible to discriminate, in performance tendencies, an unpreferable performance habit and preferable performance individuality.

[Modifications]

The aforementioned embodiment can be modified as follows. It is noted that the aforementioned embodiment and the following modifications can be appropriately combined.

If a performance is reproduced in accordance with a performance file having been specified in the performance tendency, the control section 201 may reproduce the performance with the content of a difference emphasized in reproducing the performance of a prior-play period FS or a posterior-play period BS. For example, in a performance segment having been specified to have a tendency of an early timing on the basis of Rule 1, the control section 101 emits a sound of a note rather earlier than the date/time information included in the performance file. Alternatively, in a performance segment having been specified to have a tendency of a delayed timing on the basis of Rule 2, the control section 101 emits a sound of a note rather delayed from the date/time information included in the performance file. Besides, in a performance segment having been specified to have a tendency of an early timing or a delayed timing on the basis of Rule 1, the control section 101 emits a sound with a higher velocity (namely, in a larger volume) than in the performance file.

Specifically, the control section 101 functions as a reproduction section for reproducing a performance on the basis of performance information and reproducing, in a performance segment determined to have a small difference degree, the performance with the content of a difference emphasized. As a result, the performance is reproduced with the performance tendency emphasized, and hence, the player can easily recognize his/her own performance tendency.

If a performance is reproduced on the basis of a performance file having been specified in the performance tendency, at the same time as the reproduction, a beat sound may be reproduced at a tempo in accordance with the performance file. Thus, the change in tempo of the performance can be easily recognized.

Incidentally, a unit for specifying a performance tendency is not necessarily a prescribed number of bars of a tune, but the performance tendency may be specified, for example, with respect to each player or each tune played by the player.

The performance reference information may be model data based on a musical score as in the embodiment, or may be average values derived from the tune played by the player or a plurality of tunes played by the player. Alternatively, it may be average values obtained based on another player different from the player.

Besides, the control section 201 may record change over time of the performance habit or individuality so as to calculate a progress degree of the performance on the basis of recorded data. Furthermore, the control section 201 may predict a progress degree attained in future on the basis of change over time of the progress degree. In addition, if the change on a change curve of the progress degree becomes small, the control section 201 may inform the player of this to encourage him/her to practice. The recorded change over time of the performance habit or individuality or the change curve of the progress degree of the performance may be displayed in the form of a graph.

Although the electronic musical instrument 10 is an automatic playing piano having the mechanism of an acoustic piano in the aforementioned embodiment, the electronic musical instrument 10 is not limited to the automatic playing piano. It may be, for example, an electronic piano not having the mechanism of an acoustic piano, or a keyboard instrument such as an electronic keyboard. Alternatively, it may be an acoustic instrument not having a function of an electronic instrument. Furthermore, it may be an instrument different from a keyboard instrument, such as a stringed instrument like a guitar, or a wind instrument like a trumpet.

Although the performance information includes MIDI messages and date/time information in the aforementioned embodiment, it is not limited to MIDI messages. The performance information may be, for example, waveform data of performance sounds collected by using a microphone.

Although the electronic musical instrument 10 transmits a performance file to the server device 20 in the aforementioned embodiment, the present invention is not limited to this configuration. For example, MIDI messages generated by the electronic musical instrument 10 and date/time information may be output to a computer device (such as a personal computer, a smart phone or a tablet terminal) connected to the interface 150. When this configuration is employed, the operations for starting and ending the recording of a performance may be conducted in the computer device, so as to store a performance file in the computer device. In such a case, the computer device connected to the interface 150 functions as a musical-performance analysis device.

Alternatively, the electronic musical instrument 10 itself may store a performance file to analyze it. In this case, the electronic musical instrument 10 functions as a musical-performance analysis device.

Although the date/time information of the performance file and the performance reference information are used for the comparison in the aforementioned embodiment, relative times between notes may be included as time information in a performance file and performance reference information, so as to use this time information (the relative times) for the comparison.

As another modification, with the specified performance tendency stored in the storage section 102 or the storage section 202, performance information may be generated by adding this performance tendency to score information (information free from a habit and individuality). Thus, performance information including the performance habit and individuality of a player can be generated. Besides, the generated performance may be reproduced for auralization.

As still another modification, performance tendencies of a plurality of players with respect to the same tune may be compared with one another to grasp the individuality of each player. For example, in the performance tendencies of a plurality of players, an average of information pertaining to timings may be obtained, so that the individuality of one player, such that he/she has a performance tendency of an earlier timing than the other players, can be obtained through comparison with this average.

The present invention can be practiced in the form of not only the musical-performance analysis device but also a musical-performance analysis method conducted by a computer or a program for causing a computer to function as a musical-performance analysis device. Such a program can be provided in the form of a recording medium such as an optical disk in which the program is recorded, or in the form of a program to be downloaded to a computer through a network such as the Internet and installed to be usable.

The present disclosure is summarized as follows:

(1) A musical-performance analysis method includes: an acquisition step of acquiring performance information of a player; a determination step of determining, by comparing the performance information acquired in the acquisition step with reference information corresponding to a reference of a performance, among performance segments different from one another, a performance segment in which a difference degree between the performance information acquired in the acquisition step and the reference information is large and a performance segment in which the difference degree between the performance information acquired in the acquisition step and the reference information is small; and a specification step of specifying a tendency of the performance on the basis of the difference degree of the performance segment in which the difference degree has been determined to be small in the determination step.

(2) For example, the musical-performance analysis method further includes a reproduction step of reproducing the performance on the basis of the performance information, and the performance is reproduced, in the reproduction step, with a difference content emphasized in the performance segment in which the difference degree has been determined to be small.

(3) For example, the musical-performance analysis method further includes a similarity determination step of determining, by comparing a tendency of a performance of a player precedently prepared with the tendency of the performance specified in the specification step, similarity between the tendency of the performance of the player and the tendency of the performance specified in the specification step.

(4) For example, in the specification step, the tendency of the performance is specified with respect to each player, with respect to each tune played by the player, or with respect to a prescribed number of bars of the tune.

(5) For example, in the determination step, the difference degree is obtained by comparing the performance information acquired in the acquisition step with the reference information corresponding to the reference of the performance in terms of each note.

(6) For example, a musical-performance analysis device includes: an acquisition section for acquiring performance information of a player; a determination section for determining, by comparing the performance information acquired by the acquisition section with reference information corresponding to a reference of a performance, among performance segments different from one another, a performance segment in which a difference degree between the performance information acquired by the acquisition section and the reference information is large and a performance segment in which the difference degree between the performance information acquired by the acquisition section and the reference information is small; and a specification section for specifying a tendency of the performance on the basis of the difference degree of the performance segment in which the difference degree has been determined to be small by the determination section.

(7) For example, the musical-performance analysis device further includes a reproduction section for reproducing the performance on the basis of the performance information, which reproduces the performance with a difference content emphasized in the performance segment in which the difference degree has been determined to be small.

(8) For example, the musical-performance analysis device further includes a similarity determination section for determining, by comparing a tendency of a performance of a player precedently prepared with the tendency of the performance specified by the specification section, similarity between the tendency of the performance of the player and the tendency of the performance specified by the specification section.

(9) For example, the specification section specifies the tendency of the performance with respect to each player, with respect to each tune played by the player, or with respect to a prescribed number of bars of the tune.

(10) For example, the determination section obtains the difference degree by comparing the performance information acquired by the acquisition section with the reference information corresponding to the reference of the performance in terms of each note.

The present invention has been described in detail with reference to a specific embodiment so far, and those skilled in the art will readily recognize that various modifications and changes can be made without departing from the spirit and the scope of the present invention.

This application is based upon the prior Japanese patent application (Japanese Patent Application No. 2013-108708) filed on May 23, 2013, the entire contents of which are incorporated herein by reference.

### INDUSTRIAL APPLICABILITY

According to the musical-performance analysis method and the musical-performance analysis device of the present invention, a performance tendency can be specified distinguishably from a failure or a mistake made in a performance.

### REFERENCE SIGNS LIST

1 . . . musical-performance analysis system, 10 . . . electronic musical instrument, 20 . . . server device, 101 . . . control section, 102 . . . storage section, 103 . . . touch panel, 105 . . . communication section, 107 . . . sensor section, 108 . . . drive section, 150 . . . interface, 201 . . . control section, 202 . . . storage section, 203 . . . display section, 204 . . . operation section, 205 . . . communication section

1. A musical-performance analysis method, comprising:
an acquisition step of acquiring performance information of a player;
a determination step of determining, by comparing the performance information acquired in the acquisition step with reference information indicating a reference of a performance, among performance segments different from one another, a performance segment in which a difference degree between the performance information acquired in the acquisition step and the reference information is large and a performance segment in which the difference degree between the performance information acquired in the acquisition step and the reference information is small; and
a specification step of specifying a tendency of the performance on the basis of the difference degree of the performance segment in which the difference degree has been determined to be small in the determination step.

2. The musical-performance analysis method according to claim 1, further comprising:
a reproduction step of reproducing the performance on the basis of the performance information,
wherein the performance is reproduced, in the reproduction step, with a difference content emphasized in the performance segment in which the difference degree has been determined to be small.

3. The musical-performance analysis method according to claim 1, further comprising:
a similarity determination step of determining, by comparing a tendency of a performance of a player precedently prepared with the tendency of the performance specified in the specification step, similarity between the tendency of the performance of the player and the tendency of the performance specified in the specification step.

4. The musical-performance analysis method according to claim 1, wherein the tendency of the performance is specified, in the specification step, with respect to each player, with respect to each tune played by the player, or with respect to a prescribed number of bars of the tune.

5. The musical-performance analysis method according to claim 1, wherein the difference degree is obtained, in the determination step, by comparing the performance information acquired in the acquisition step with the reference information corresponding to the reference of the performance in terms of each note.

6. A musical-performance analysis device, comprising:
an acquisition section that acquires performance information of a player;
a determination section that determines, by comparing the performance information acquired by the acquisition section with reference information indicating a reference of a performance, among performance segments different from one another, a performance segment in which a difference degree between the performance information acquired by the acquisition section and the reference information is large and a performance segment in which the difference degree between the performance information acquired by the acquisition section and the reference information is small; and
a specification section that specifies a tendency of the performance on the basis of the difference degree of the performance segment in which the difference degree has been determined to be small by the determination section.

7. The musical-performance analysis device according to claim 6, further comprising:
a reproduction section that reproduces the performance on the basis of the performance information,
wherein the reproduction section reproduces the performance with a difference content emphasized in the performance segment in which the difference degree has been determined to be small.

8. The musical-performance analysis device according to claim 6, further comprising:
a similarity determination section that determines, by comparing a tendency of a performance of a player precedently prepared with the tendency of the performance specified by the specification section, similarity between the tendency of the performance of the player and the tendency of the performance specified by the specification section.

9. The musical-performance analysis device according to claim 6, wherein the specification section specifies the tendency of the performance with respect to each player, with respect to each tune played by the player, or with respect to a prescribed number of bars of the tune.

10. The musical-performance analysis device according to claim 6, wherein the determination section obtains the difference degree by comparing the performance information acquired by the acquisition section with the reference information indicating the reference of the performance in terms of each note.
